(19) United States
(12) Patent Application Publication
(10) Pub. No.: US 2019/0049291 A1
(43) Pub. Date: Feb. 14, 2019

(54) System and Apparatus for Automated Public Scale

(71) Applicant: Berrye, LLC, Clearwater, FL (US)

(72) Inventors: Dag A. Rasen, Palm Harbor, FL (US); Maurycy J. Sokolowski, Largo, FL (US)

(73) Assignee: BERRYE, LLC, CLEARWATER, FL (US)

(21) Appl. No.: 16/052,736

(22) Filed: Aug. 2, 2018

Related U.S. Application Data
(60) Provisional application No. 62/544,963, filed on Aug. 14, 2017.

(51) Int. Cl. G01G 23/37; G01G 19/02; G06Q 20/32

(52) U.S. Cl. CPC G01G 23/3742; G06Q 20/3224; G01G 19/021; G01G 23/3721

(57) ABSTRACT

A system for making public a scale includes a device for capturing a weight from the scale and hardware for storing the weight and associating the weight with the scale (in some embodiments, the weight is periodically transferred to a server for central storage). There is a user interface for directing an operator having a vehicle to the scale and mechanisms for determining that the operator, and hence the vehicle, are located on the scale. Once on the scale, a weigh-bill is generated from the weight and the weigh-bill is communicated to the operator

### CROSS-REFERENCE TO RELATED APPLICATION

This application claims the benefit of U.S. provisional application No. 62/544,963 filed on Aug. 14, 2017, the disclosure of which is incorporated by reference.

### FIELD

This invention relates to the field of weights and measurements and more particularly to a system for advertising and utilizing a privately owned scale as a public scale.

### BACKGROUND

There are many instances when a weight of a vehicle needs to be known and/or recorded. For example, a driver needs to know the weight of his or her truck before driving on a highway, particularly if there is a weight limit on one or more bridges of that highway. Often, truckers need to know the weight of a load for billing reasons. Recyclers often weigh vehicles loaded, then unloaded; the difference being the amount of material that was unloaded and, therefore, the fee the recycler needs to pay. Elevators often have scales to weigh crop loads to know how much material (e.g. grain, corn, soy bean) a farmer is depositing in the elevator.

There are many public scales, typically along major trucking routes. These public scales typically charge the operator of the vehicle a fee (e.g. $10.00 to $15.00) to weigh their vehicle and generate a printout indicating the weight of the vehicle.

Unfortunately, an operator often needs to know the weight of the vehicle at a location where there is no public scale, often before entering into such major trucking routes.

There exist a large number of private scales located throughout most countries. For example, in the United States, it is estimated that there are upwards of over 100,000 private scales scattered throughout the country. Many of these scales are used seldom or seasonally. For example, a grain elevator may utilize their scale constantly during a few weeks or months of harvest and rarely use that scale the remainder of the year.

Owners of private scales would find it financially rewarding to open there scale to the public, but there are several drawbacks to opening their scales. First, the process of generating a receipt showing the weight often requires an in-door system with a printer. Second, the process of collecting payment for use of the scale often requires a credit card scanner. Third, both require an operator to print the receipt and accept payment. Fourth, all of the above operations take time that the operator finds is better to use transporting the load then waiting to pay for the use of the scale.

What is needed is a system that will open and advertise a scale to the public and simplify the task of generating a receipt showing the weight of the vehicle.

### SUMMARY

In one embodiment, a system is disclosed for making public a scale. The system includes a device for capturing a weight from the scale and hardware for storing the weight and associating the weight with the scale (in some embodiments, the weight is periodically transferred to a server for central storage). A user interface directs an operator having a vehicle to the scale and there is a mechanism for determining that the operator, and hence the vehicle, are located on the scale (e.g. using location services of a cell phone). Once on the scale, a weigh-bill is generated from the weight and the weigh-bill is communicated to the operator.

In another embodiment, a system is disclosed for making public a scale. The system includes a way to capture a weight from the scale and a way to store the weight and associating the weight with the scale. There is a way for an operator of a vehicle to move the vehicle onto the scale and a way to determine that the vehicle is located on the scale. There is a way to generate a weigh-bill from the weight, t including an identification of the vehicle and there is a way to communicate (e.g. send or transmit) the weigh-bill to the operator.

In another embodiment, a system is disclosed for making public a scale. The scale has an electrical interface for communicating weight measurements. A computer connected to the electrical interface; thereby the computer receives the weight measurements. An application runs on a user device; the user device being associated with and residing within a vehicle. Until the computer determines that the vehicle is on the scale based upon a location of the user device, the application reads the location coordinates of the vehicle from the user device (e.g. GPS subsystem of a cell phone) and the application transmits the location coordinates of the user device to the computer. After the computer determines that the vehicle is on the scale based upon the location of the user device, the computer generates a weigh-bill from the weight received over the electrical interface. The weigh-bill includes an identification of the vehicle. The computer then transmits the weigh-bill to the user device.

In another embodiment, a system is disclosed for making public a scale. The scale has an electrical interface for communicating weight measurements. The system includes a computer connected to the electrical interfaced such that the computer receives the weight measurements. Software runs on a user device, the user device being associated with and residing within a vehicle. Until software running on the computer determines that the vehicle is on the scale based upon a location of the user device, the software running on the user device reads the location of the vehicle from the user device (e.g. GPS location of the user device) and the software running on the user device transmits the location of the user device to the computer. After the software running on the computer determines that the vehicle is on the scale based upon the location of the user device, the software running on the computer generates a weigh-bill from a weight received over the electrical interface. The weigh-bill includes an identification of the vehicle. The software running on the computer transmits the weigh-bill to the software running on the user device and the software running on the user device displays the weigh-bill and stores the weigh-bill for future retrieval.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the system for automated public scales.

FIG. 2 illustrates a schematic view of a typical cell phone.

FIG. 3 illustrates a schematic view of a typical computer system such as a server or personal computer.

FIG. 4 illustrates a scale interfaced to the system for automated public scales.

FIG. 5 illustrates a cell phone user interface for logging onto the system for automated public scales.

FIG. 6 illustrates a cell phone user interface for finding an advertised scale in the system for automated public scales.

FIG. 7 illustrates a cell phone user indicating the vehicle is on the scale and ready for weighing in the system for automated public scales.

FIG. 8 illustrates a cell phone user interface for displaying a weight measurement from a scale in the system for automated public scales.

FIG. 9 illustrates a flowchart of generating a weigh-bill from a scale in the system for automated public scales.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

In general, the system for automated public scales provides capabilities to advertise a private scale that is now open for public use and to obtain measurements (e.g. weight) from that scale by email, text message, printout, logging, etc.

Although described with respect to a scale, the system is anticipated to be used in any geographic point of sale. For example, knowing the location of the cell phone and, hence owner/user of the cell phone, an application can present a simple purchase user interface for purchasing a registered item at the location of the owner/user. In such, when the owner/user is next to a particular item (for example, a vehicle on a car lot or a palate at a superstore, it is anticipated that a user interface be presented indicating the item that is nearby, the cost, and an input for quantity (if multiple of the item is available), and a directive for purchasing the item using pre-stored payment information.

Throughout the description, the vehicle operator has a device for communicating with the system for automated public scales. For simplification, a cell phone 10 is used in all examples, but any device having location services it is fully anticipated, for example, tablet computers, on-board vehicle computers, etc.

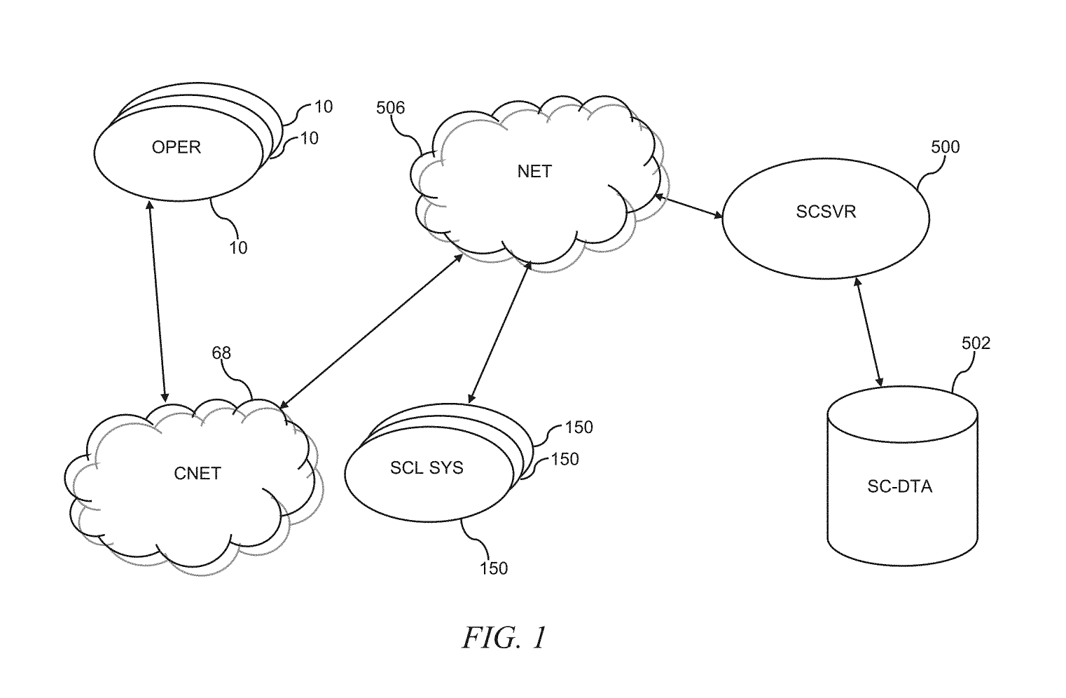

Referring to FIG. 1 illustrates a data connection diagram of the exemplary system for automated public scales. In this example, one or more cell phones 10 associated with operators (e.g. truck drivers) communicate through the cellular network 68 and/or through a wide area network 506 (e.g. the Internet) to a server computer 500.

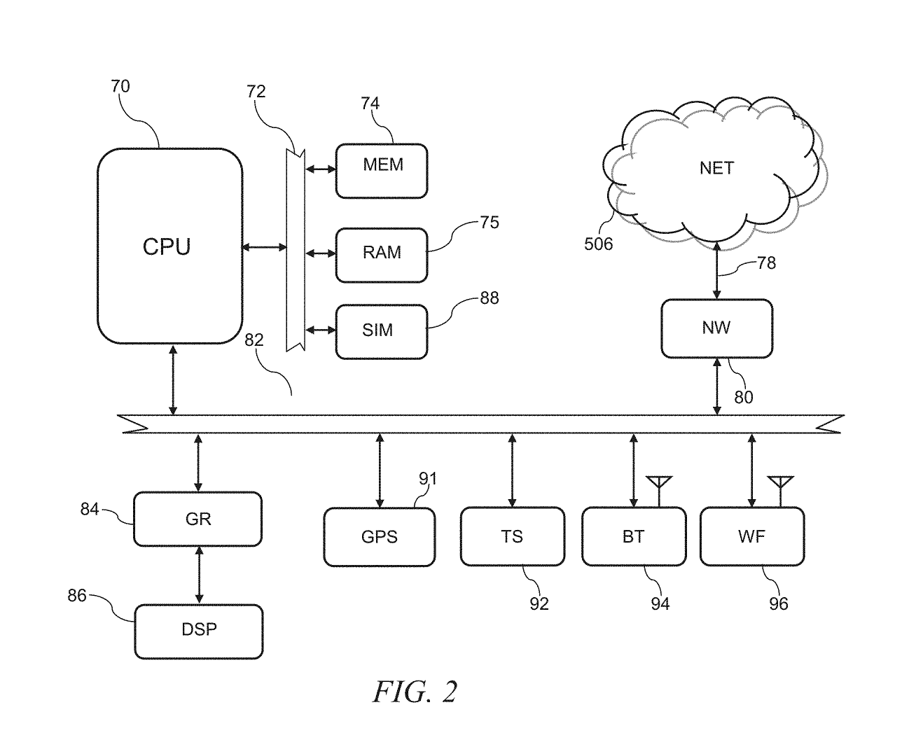

The server computer 500 has access to data storage 502. Although one path between the cell phones 10 and the server 500 is through the cellular network 68 and the wide area network 506 as shown, any known data path is anticipated. For example, the Wi-Fi transceiver 96 (see FIG. 2) of the cell phone 10 is used to communicate directly with the wide area network 506, which includes the Internet, and, consequently, with the server computer 500.

The server computer 500 transacts with the cell phones 10 through the network(s) 68/506 to present menus to/on the cell phones 10, provide data to the cell phones 10, and to communicate information such user credentials, etc. In some embodiments, login credentials (e.g., passwords, pins, secret codes) are stored local to the cell phone 10; while in other embodiments, login credentials are entered each time the operator logs in.

The server computer 500 transacts with applications running on the cell phones 10, responding to requests and providing data. The server computer 500 also transacts with one or more scale systems 150 to receive measurements (e.g. a weight of a vehicle).

The geographic location of the cell phone 10 is determined by reading the GPS subsystem 91 (see FIG. 2) of the cell phone 10. This geographic location is used by the server 500 to determine when the cell phone 10 of the operator is located on the scale. Therefore, the operator's vehicle is on the scale. Further, the server computer 500 monitors weight readings from the scale and makes sure the weight reading is greater than a predetermined threshold (e.g. at least greater than zero). This helps compensate for the known tolerances of GPS locating services.

Referring to FIG. 2, a schematic view of a typical cell phone 10 is shown. The example cell phone 10 represents a typical phone system used for accessing user interfaces of the system for automated public scales. This exemplary cell phone 10 is shown in one anticipated form, though different architectures are known that accomplish similar results in a similar fashion and the present invention is not limited in any way to any particular cell phone 10 system architecture or implementation. In this exemplary cell phone 10, a processor 70 executes or runs programs in a random access memory 75. The programs are generally stored within a persistent memory 74 and loaded into the random access memory 75 when needed. Also accessible by the processor 70 is a SIM (subscriber information module) card 88 having a subscriber identification and often persistent storage. The processor 70 is any processor, typically a processor designed for phones. The persistent memory 74, random access memory 75, and SIM card are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, magnetic memory, etc. In some exemplary cell phones 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on a display image on the display 86. The touch screen interface 92 provides navigation and selection features.

In general, some portion of the persistent memory 74 and/or the SIM card 88 is used to store programs, executable code, phone numbers, contacts, and data, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, Bluetooth transceiver 94, Wi-Fi transceiver 96, cameras, microphone, image sensors, temperature sensors, etc., the details of which are not shown for brevity and clarity reasons.

The cellular network interface 80 connects the cell phone 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the cell phone 10 through the cellular network.

For local communications, many cell phones 10 include a Bluetooth transceiver 94, a Wi-Fi transceiver 96, or both. Such features of cell phones 10 provide data communications between the cell phones 10 and data access points and/or other computers such as a personal computer (not shown).

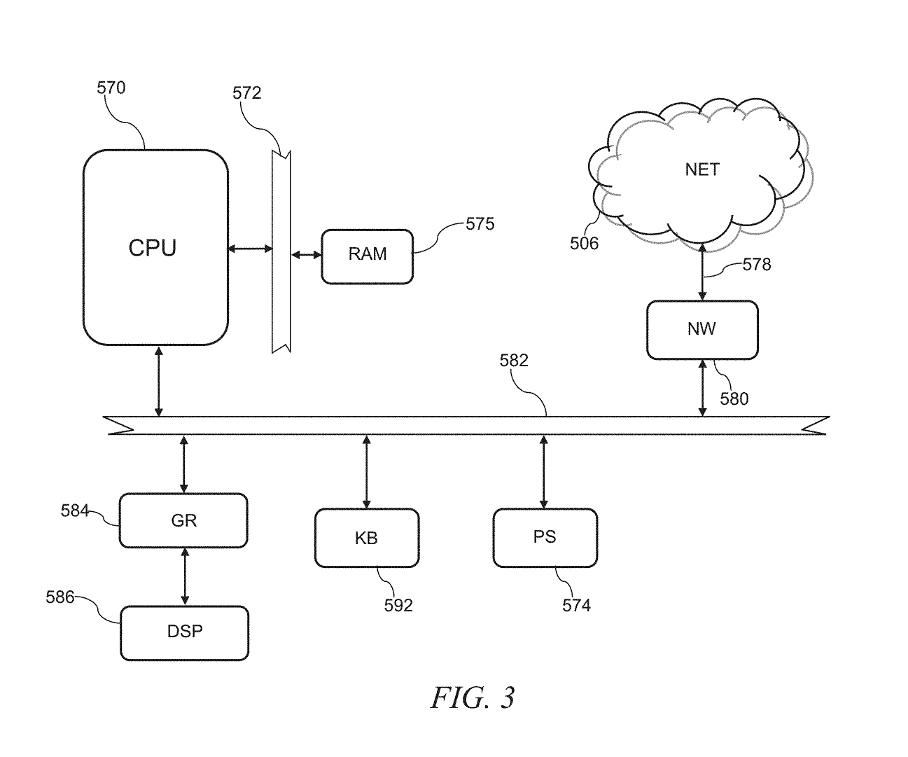

Referring to FIG. 3, a schematic view of a typical computer system (e.g., server 500) is shown. The example computer system 500 represents a typical computer system used for recording/storing measurements (e.g. weights), generating weigh reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features.

In general, some portion of the persistent memory 574 is used to store programs, executable code, data, contacts, and other data, etc.

The peripherals are examples and other devices are known in the industry such as speakers, microphones, USB interfaces, Bluetooth transceivers, Wi-Fi transceivers, image sensors, temperature sensors, etc., the details of which are not shown for brevity and clarity reasons.

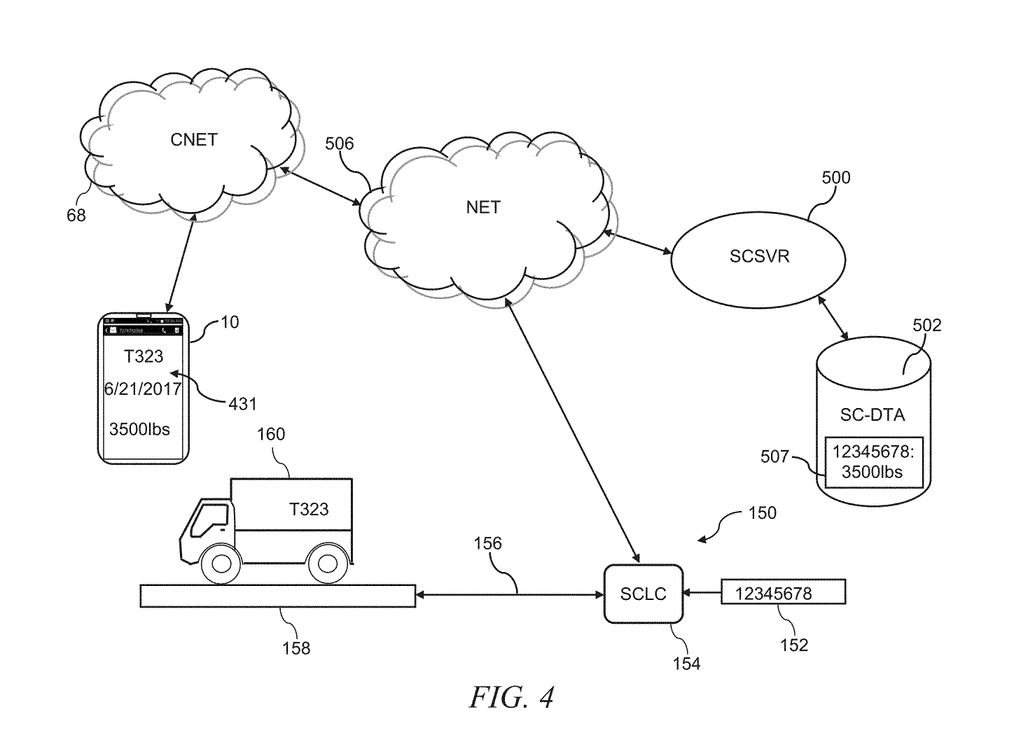

Referring to FIG. 4, a scale 158 is shown interfaced to the system for automated public scales. There are many scales 158 in existence, often utilized for private use only. For example, many grain elevators have scales 158 for weighing grain as loads of grain arrive/leave the elevator. These scales 158 art typically heavily used during harvest but only used occasionally during the remainder of the year. The system for automated public scales provides mechanisms for the owner of the elevator to provide the scales 158 for public use during the remainder of the year by advertising the scales 158 to operators who subscribe to the automated public scales service at times when the scales 158 are open to the public. Further, system for automated public scales provides automated mechanisms for locating the scales 158, weighing the operator's vehicle 160, distributing the weigh-bill 431, and obtaining payment from the operator, without requiring additional staff.

The scale 158 typically communicates measurements by way of a communications link 156 as known, wired or wireless; for example, RS-232, Universal Serial Bus (USB), 802.3 (Ethernet), 802.11 (Wi-Fi), 802.15 (Bluetooth), etc. Typically, there is a scale system that reads the data from the scale 158 and displays/prints the data (weight, etc.). A scale controller 154 is connected to the scale 158. The scale controller 154 has a scale identification 152 (e.g. a serial number), and periodically, the scale controller 154 transmits the data from the scale 158 and, optionally the scale identification 152, to the server 500 through the network 506 or through any known form of digital data communication. The server 500 stores the data and, optionally, the scale identification 152 in a record 507 within the data storage 502 (e.g. storage local to the server 500, cloud storage, etc.). It is fully anticipated that, in some embodiments, the cell phone 10 has tables of locations of each scale 158 and internet addresses (unique address) of the associated scale controllers 154, such that the cell phone 10 will directly communicate with the scale controller 154 to obtain the weight and generate the weigh-bill 431 locally at the cell phone 10, without using a server.

When the operator is located on the scale 158 as defined by the location of the operator's cell phone 10 being at the location of the scale 158 (e.g. by GPS or triangulation or any location service of the cell phone 10) and the operator initiates a request for a weighing, the server 500 receives the request, reads the data from the record 507 in the data storage 502, formats the requested reading as required, and transmits the formatted reading to the operator's cell phone 10 or any other registered recipient (e.g. central dispatch, etc.). In the example shown, this weigh-bill 431 includes the weight of the operator's vehicle 160 is 3500 lbs. Note that in the process or logging in, data on the operator's cell phone or an association between the operator and the operator's vehicle 160 provide the truck identifier (e.g. T323) for inclusion on the report shown presented on the display 86 of the operator's cell phone 10.

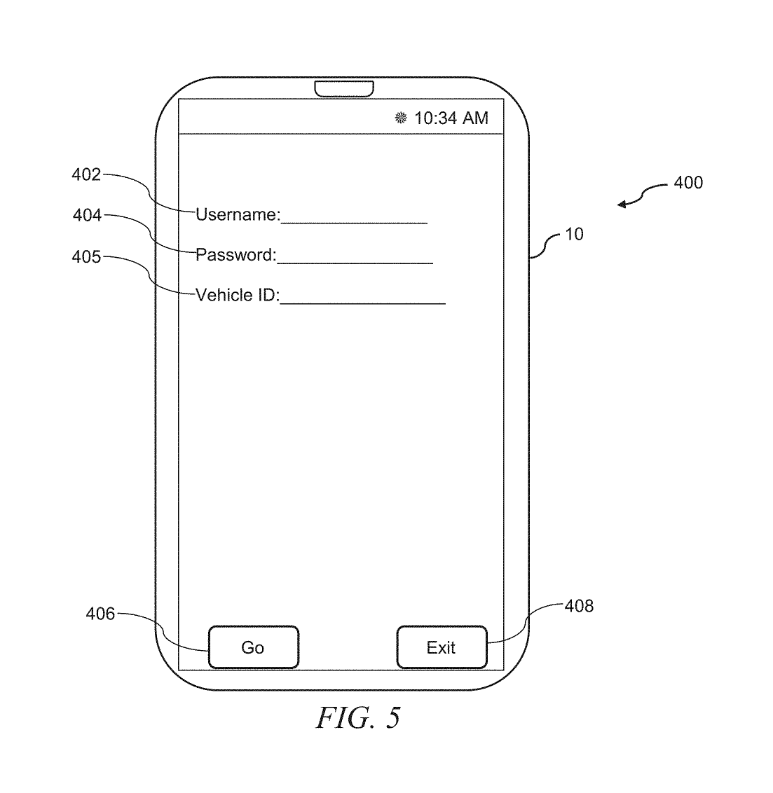

Referring to FIG. 5, a cell phone user interface for logging in 400 the system for automated public scales is shown. Although many user interfaces are anticipated, the user interfaces shown in FIGS. 5-8 are examples and are not intended to be limiting in any way.

After downloading and installing the user application for the system for automated public scales, the operator creates a username 402 and password 404, which is entered in user interface for logging in 400 and the “go” directive 406 is selected to gain access to the system for automated public scales. In some user interfaces, a “exit” directive 408 is provided to exit without logging in. Additionally, the operator enters an identification 405 of the operator's vehicle 160 that is included in the resulting weigh-bill 431. In some embodiments, typically when the operator owns the operator's vehicle 160, the identification 405 is pre-configured in the application and need not be entered with every use.

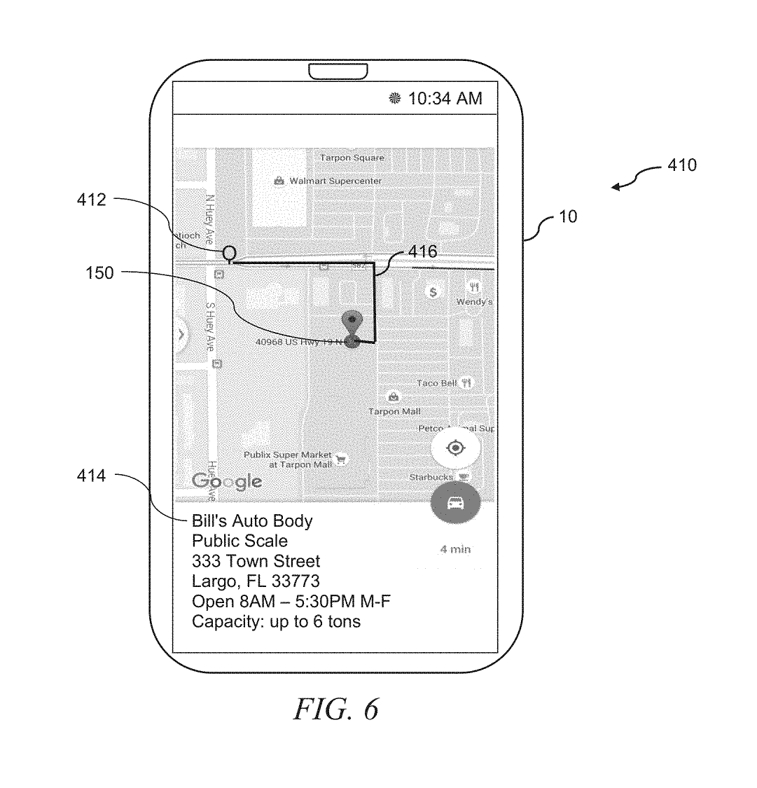

Referring to FIG. 6, a cell phone user interface for finding 410 an advertised scale in the system for automated public scales is shown. The user interface for finding 410 an advertised scale is typically displayed once the operator login process (see FIG. 5) completes and the operator enters a username 402 and password 404 that are valid.

In this exemplary user interface for finding 410 an advertised scale, a map is shown indicating the current location of the operator (and the operator's vehicle 160 if the operator is within the operator's vehicle 160) and indicating the location of the scale system 150 that is nearest as advertised. In some embodiments, information 414 regarding the scale system 150 that is nearest as advertised is shown. Note that although a single system 150 is shown, any number of systems 150 are anticipated to be found and shown on the map of the user interface for finding 410 an advertised scale.

In operation, the application running on the operator's cell phone 10 consults a location service of the cell phone 10 to determine an absolute location of the cell phone 10, then communicating with the server 500 through the network(s) 68/506, the application obtains the map details showing the scale system(s) 150 locally advertised and, optionally, the route 416 to each such scale system(s) 150. Location services are known in the art of cell phones 10 and typically utilize either cell tower triangulation or global positioning via the GPS receiver 91 of the cell phone 10.

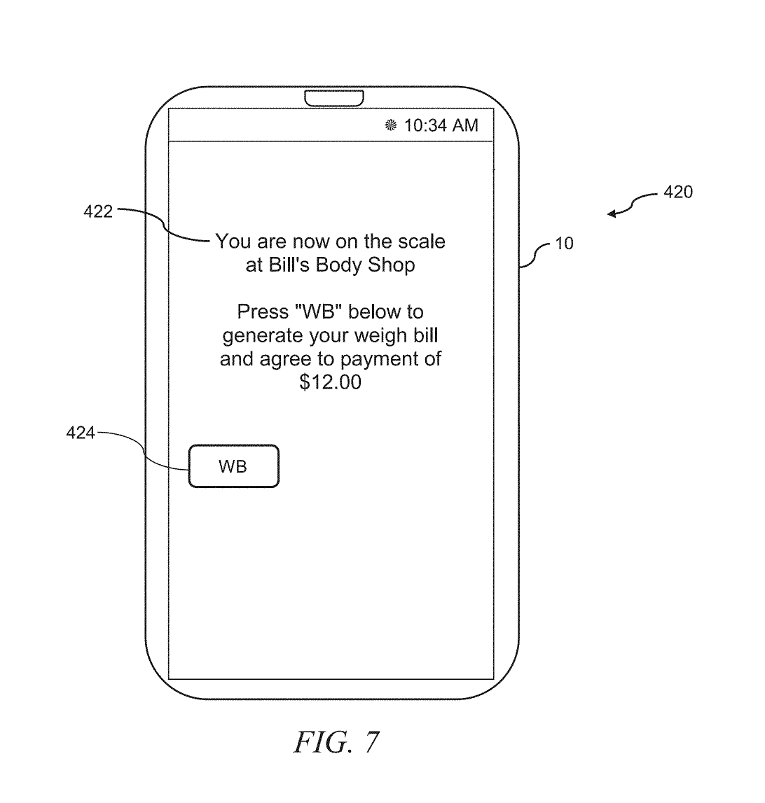

Referring to FIG. 7, a cell phone user interface indicating 420 the vehicle is on the scale and ready for weighing in the system for automated public scales is shown. The cell phone user interface indicating 420 the vehicle is on the scale and ready for weighing is displayed when the application, using the location services of the cell phone 10, determines that the cell phone's 10 location matches that of the scale 158 of an scale system 150 that is advertised. The scale system(s) 150, for example, provides a message 422 informing the operator that they are located upon the scale 158 of the scale system 150 and of the cost that will be incurred to generate a weigh-bill 431 (e.g. $12.00). Note, as the weight measurement from the scale 158 is periodically transmitted to the server 500, it is anticipated that, for operator information, the weight is also displayed on the user interface indicating 420 the vehicle is on the scale and ready for weighing, perhaps to help the operator know that the vehicle is correctly located on the scale 158 without any wheels being partially on the scale 158.

In some embodiments, the provider of the application obtains compensation from the owner of the scale 158 as a fixed fee while in some embodiments; the provider of the application obtains compensation from the owner of the scale 158 as an agreed upon percentage of the cost to generate the weigh-bill 431 while in some embodiments; the provider of the application obtains compensation for advertisers who advertise on the user interfaces of the application. Any combination of such and/or the addition of different types of compensation are anticipated.

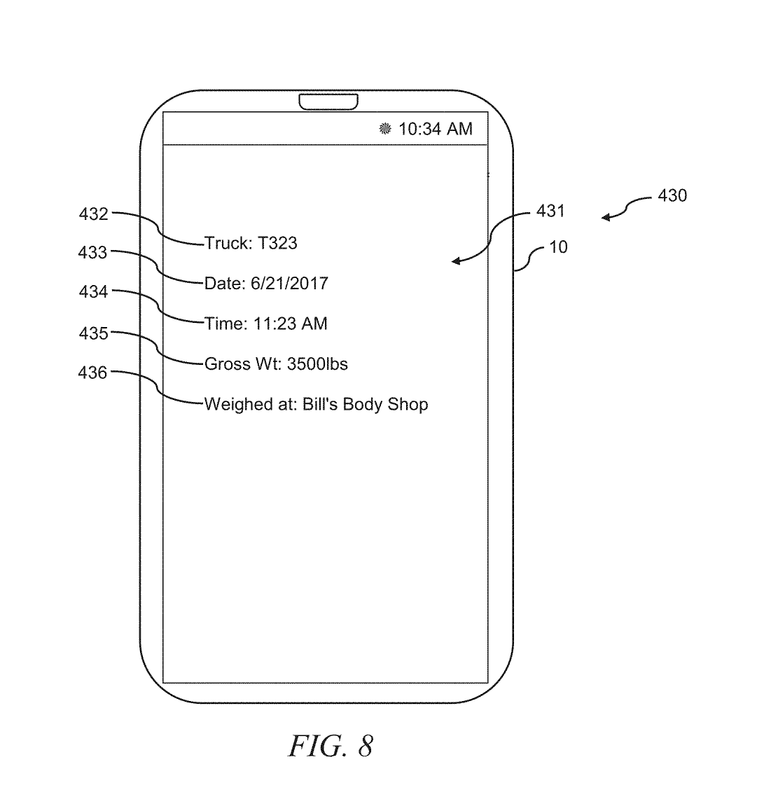

When the operator agrees to payment and requests the weigh-bill 431 by selecting the “WB” directive 424, the server 500 retrieves current data (weight reading) and, optionally, the scale identification 152 from the record 507 within the data storage 502 and formats a weigh-bill 431, for example, the weigh-bill 431 shown in FIG. 8. The weigh-bill 431 is then transmitted to the application running on the operator's cell phone 10 or distributed as requested by the operator, for example, printed at the scale system 150, transmitted to a Bluetooth printer (either within the operator's vehicle 160 or at the scale system 150) emailed to the operator, emailed to a dispatcher, sent as a text message, logged, etc. In some embodiments, the weigh-bill 431 is given a unique identification and recorded in the application as well as saved in the data storage 502, for example, utilizing encryption to secure the data and prevent tampering.

In operation, the application running on the operator's cell phone 10 consults a location service of the cell phone 10 to determine an absolute location of the cell phone 10, then communicating with the server 500 through the network(s) 68/506, the application and/or server 500 compares the location of the cell phone 10 with a stored location of the scale 158 of the scale system 150. If the comparison is within a tolerance for error, then it is assumed that the operator's cell phone 10 (and hence the operator and the operator's vehicle 160) is located on the scale 158 of the scale system 150. Location services are known in the art of cell phones 10 and typically utilize either cell tower triangulation or global positioning via the GPS receiver 91 of the cell phone 10.

Referring to FIG. 8, a cell phone user interface for displaying 430 a weight measurement from a scale in the system for automated public scales is shown. The user interface for displaying 430 a weight measurement from an scale system 150, for example, includes an identification of the vehicle 432 (e.g. “T323”), the date of weighing 433, the time of weighing 434, the gross weight 435 of the operator's vehicle 160, and a location 436 at which the operator's vehicle 160 was weighed.

Given the above system, it is anticipated that the operator will have, at least one or more of the following features available:
An application that will identify the location of the scale 158, and provide information regarding the scale 158 such as opening hours, pricing (fixed pricing in first versions), address, telephone, scale length and capacity, and connection to the scale indicator.
Ability to obtain a weigh-bill 431 ticket for the vehicle 160 that is located on the scale 158.
Provide a log that includes date and time for each weighing, and a revenue for the scale 158.
The operator will have the ability to add account information, including a credit card number (in some embodiments, the credit card information is maintained by a third party such as authorize.net).

In some embodiments, the operator has the ability to edit non-critical data of a weighing and print a copy of the weigh-bill with those edits.

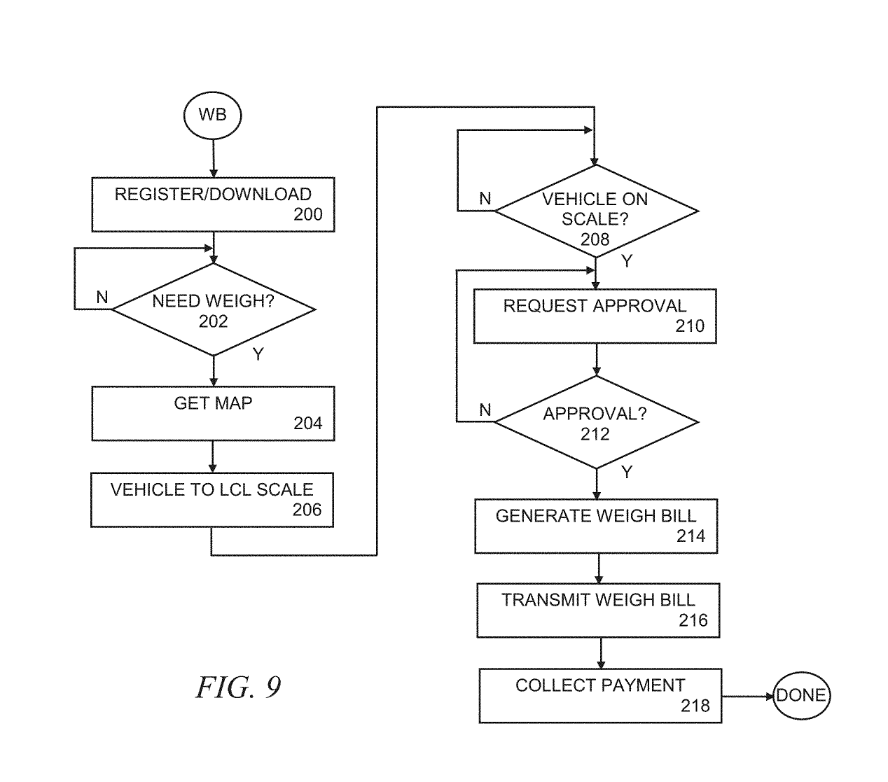

Referring to FIG. 9, a flowchart of generating a weigh-bill 431 from a scale in the system for automated public scales is shown. The process begins when a driver (or company, etc.) registers 200 a device (e.g. cell phone 10) and downloads an application to the device (e.g. cell phone 10). Now, when it is determined 202 by the operator (or other person) that a weigh-bill 431 is needed, the application generates a map 204 displaying locations of the scale system(s) 150. The operator then proceeds by moving 206 the vehicle 160 to the scale 158 of the selected scale system 150. At the scale 158, the server 500 monitors the location of the vehicle 160 and, optionally monitors the weight registered by the scale 158, and determines 208 if the vehicle 160 is on the scale 158.

If it is determined 208 that the vehicle 160 is on the scale 158, the server 500 transacts with the application running on the cell phone 10 to request approval 210 as in the user interface 420 indicating that the vehicle 160 is on the scale 158. In some embodiments, the request for approval includes the current weight measured by the scale 158. In some embodiments, the request for approval includes the cost to generate the weigh-bill 431.

Once the operator selects the approval button 212 (e.g. executed the “WB” directive 424), the server 500 generates 214 the weigh-bill 431 and transmits 216 the weigh-bill 431 to the cell phone 10, for example by Wi-Fi, by Bluetooth, by cellular data, etc.

Finally, payment is collected 218 (e.g. through a credit card provided during registration 200 or during the approval 212, or in cash to the owner of the scale 150, etc.).

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for making public a scale, the system comprising:
means for capturing a weight from the scale;
means for storing the weight and associating the weight with the scale;
means for directing an operator of a vehicle to move the vehicle onto the scale;
means for determining that the vehicle is located on the scale;
means for generating a weigh-bill from the weight, the weigh-bill including an identification of the vehicle; and
means for communicating the weigh-bill to the operator.

2. The system for making public the scale of claim 1, whereas the means for capturing the weight comprises a computer the electrically receives the weight from the scale.

3. The system for making public the scale of claim 2, whereas the means for determining that the vehicle is located on the scale comprises receiving location coordinates from a device within the vehicle.

4. The system for making public the scale of claim 3, whereas the device is a cell phone and the location coordinates are read from a global positioning subsystem of the cell phone and the location coordinates are transmitted to the computer.

5. The system for making public the scale of claim 4, whereas the means for determining that the vehicle is located on the scale further comprises waiting for the weight to be greater than a predetermined threshold.

6. The system for making public the scale of claim 4, wherein the means for communicating the weigh-bill to the operator comprises transmitting the weigh-bill to an application running on the cell phone.

7. A system for making public a scale, the scale having an electrical interface for communicating weight measurements, the system comprising:
a computer connected to the electrical interface, the computer receiving the weight measurements;
an application running on a user device, the user device associated with and residing within a vehicle;
until the computer determines that the vehicle is on the scale based upon a location of the user device, the application reading the location of the vehicle from the user device and the application transmitting the location of the user device to the computer;
after the computer determines that the vehicle is on the scale based upon the location of the user device, the computer generates a weigh-bill from the weight received over the electrical interface, the weigh-bill including an identification of the vehicle; and
the computer transmits the weigh-bill to the user device.

8. The system for making public the scale of claim 7, whereas the user device is a cell phone.

9. The system for making public the scale of claim 7, whereas the computer determines that the vehicle is on the scale based upon the location of the user device and further upon a last weight measurement of the weight measurements received from the scale, the last weight measurement being greater than a predetermined threshold.

10. The system for making public the scale of claim 7, wherein the weigh-bill is transmitted to the application running on the user device over a wireless communications path.

11. The system for making public the scale of claim 10, wherein the wireless communications path is selected from the group consisting of Wi-Fi, Bluetooth, and cellular data.

12. The system for making public the scale of claim 7, wherein, before the computer transmits the weigh-bill to the user device, the computer receives payment.

13. The system for making public the scale of claim 12, wherein, the computer receives payment from a form of payment administered through the application running on the user device.

14. A system for making public a scale, the system comprising:
the scale having an electrical interface for communicating weight measurements;
a computer connected to the electrical interfaced, the computer receiving the weight measurements;
software running on a user device, the user device associated with and residing within a vehicle;
until software running on the computer determines that the vehicle is on the scale based upon a location of the user device, the software running on the user device reading the location of the vehicle from the user device and the software running on the user device transmitting the location of the user device to the computer;
after the software running on the computer determines that the vehicle is on the scale based upon the location of the user device, the software running on the computer generates a weigh-bill from a weight received over the electrical interface, the weigh-bill including an identification of the vehicle; and
the software running on the computer transmits the weigh-bill to the software running on the user device and the software running on the user device displays the weigh-bill and stores the weigh-bill for future retrieval.

15. The system for making public the scale of claim 14, whereas the user device is a cell phone.

16. The system for making public the scale of claim 14, whereas the software running on the computer determines that the vehicle is on the scale based upon the location of the user device and further upon a last weight measurement of the weight measurements received from the scale, the last weight measurement being greater than a predetermined threshold.

17. The system for making public the scale of claim 14, wherein the weigh-bill is transmitted from the software running on the computer to the software running on the user device over a wireless communications path.

18. The system for making public the scale of claim 17, wherein the wireless communications path is selected from the group consisting of Wi-Fi, Bluetooth, and cellular data.

19. The system for making public the scale of claim 14, wherein, before the software running on the computer transmits the weigh-bill to the software running on the user device, the software running on the computer receives payment.

20. The system for making public the scale of claim 19, wherein, the software running on the computer receives payment from a form of payment administered through the software running on the user device.
